(19) United States
(12) Patent Application Publication
(10) Pub. No.: US 2007/0119278 A1
(43) Pub. Date: May 31, 2007

(54) Chain clamping device for holding a saw chain to be sharpened, and a method of a sharpening a chainsaw chain using said device

(76) Inventor: Joseph R. Ranker, Dunbar, PA (US)

Correspondence Address: NILS H. LJUNGMAN;NILS H. LJUNGMAN & ASSOCIATES, P.O. BOX 130, GREENSBURG, PA, 15601, US

(21) Appl. No.: 11/288,618

(22) Filed: Nov. 29, 2005

(51) Int. Cl. B23D 61/00

(52) U.S. Cl. 76/78.1

(57) ABSTRACT

A chain clamping device for holding a saw chain to be sharpened, and a method of sharpening a saw chain using said device. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to a chain clamping device for holding a chainsaw chain to be sharpened, and a method of sharpening a chainsaw chain using said device.

2. Background Information

Powered chain saws have long been known in the art, and typically comprise a saw bar, a chainsaw chain movably carried by the saw bar, means for causing rotation of the chainsaw chain about the saw bar, and a plurality of saw teeth carried on the chainsaw chain. Like any other saw, prolonged use of the chain saw results in dulling of the saw teeth due to contact with the substances being cut. When in use, a chainsaw chain may require several sharpenings in one day in order to maintain maximum cutting efficiency. Since a chainsaw chain requires frequent sharpening, a device to hold a chainsaw chain to be sharpened should be portable and easily assembled at a work site, so that a worker does not need to leave the work site in order to sharpen a chainsaw chain.

In order to properly sharpen the cutters of a chainsaw chain it is necessary to hold the cutters firmly in place while drawing a file across the cutters at the appropriate angle. Since the shape of the chain is irregular, it is difficult to grip the chain in a manner firm enough to prevent wobble in the cutters as the file is moved back and forth. Further, the clamping device should allow the chainsaw chain to be easily advanced in order to facilitate ease and efficiency of sharpening each cutter on the chainsaw chain.

### OBJECT OR OBJECTS

The object is to provide a clamping device for holding chainsaw chains to be sharpened. The clamping device is portable, easy to use, and allows a user to efficiently sharpen a chainsaw chain in practically any location.

A further object is to provide a method of using a clamping device for holding chainsaw chains to be sharpened.

### SUMMARY

The present application relates to a chain clamping device for any size or length of chain for a chain saw. The clamping device can clamp approximately eight inches of chain at a time in a straight position along the top of the clamping device. Once one interval or section of chain has been sharpened, the clamping device can be loosened in order to release the pressure and advance the chain approximately eight inches to the next interval. This advancement can continue until the sharpening of the entire chainsaw chain is completely finished. Many teeth can be sharpened at each setting. The teeth can be sharpened with a file holder, a small mounted grinding wheel, or small hand grinder.

The chain can be sharpened in the following three general steps:

1. Sharpen every other tooth.

2. Reverse the chain direction and sharpen the remaining teeth.

3. File every raker, using a raker gauge and a file.

The clamping device is extremely sturdy and can be comprised of only three parts in one embodiment. The clamping device can be made of steel, or any other suitable metal, and may not require any parts to be welded or brazed. Since the clamping device is extremely sturdy, it can be difficult to damage, even if dropped. This would be an advantage for the user at a work site, where tools could be exposed to harsh treatment or dangerous conditions.

Since stock size steel can be used to construct the clamping device, very little machining may be required on the finished product. No tools or wrenches may be needed to use the clamping device. It can be light in weight, and can be mounted on a work bench or saw horse with two bolts or two C-clamps. In addition, the chain may always be free to move in a circle around the clamping device without interruption, and without having to remove the chainsaw chain from the clamping device in order to advance the chainsaw chain for sharpening of the next segment.

In addition to the advantageous clamping of the chainsaw chain during sharpening, the clamping device is also designed to accommodate both left-handed people and right-handed people. Further, the clamping device can accommodate any size chainsaw chain to be sharpened. The clamping device is very sturdy and has a small number of parts, so it can be taken to a work site and used repeatedly and regularly without requiring a lot of maintenance. Another advantage of the clamping device is that it can be mounted almost anywhere, and can be stored in a relatively small area.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1A shows a chainsaw chain according to one possible embodiment;

FIG. 1 shows a side perspective view of the pieces of the clamping device disassembled according to one possible embodiment;

FIG. 2 shows an overhead perspective view of the pieces of the clamping device disassembled according to one possible embodiment;

FIG. 3 shows an overhead view of the assembled clamping device, installed on a table according to one possible embodiment;

FIG. 4 shows a frontal view of the assembled clamping device, installed on a table according to one possible embodiment;

FIG. 5 shows a side view of the assembled clamping device, installed on a table according to one possible embodiment;

FIG. 6 shows a frontal view of the assembled clamping device with a chainsaw chain disposed therein according to one possible embodiment;

FIG. 7 shows a user sharpening the teeth of a chainsaw chain that is disposed in the clamping device according to one possible embodiment;

FIG. 8 shows a user sharpening the rakers of a chainsaw chain that is disposed in the clamping device according to one possible embodiment; and

FIG. 9 shows a schematic drawing showing the possible radii of curvature of the curved edges of the clamping device according to one possible embodiment.

### DESCRIPTION OF EMBODIMENT OR EMBODIMENTS

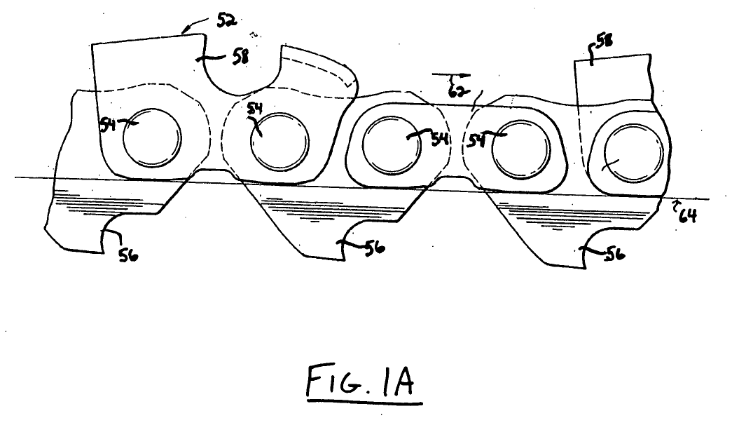

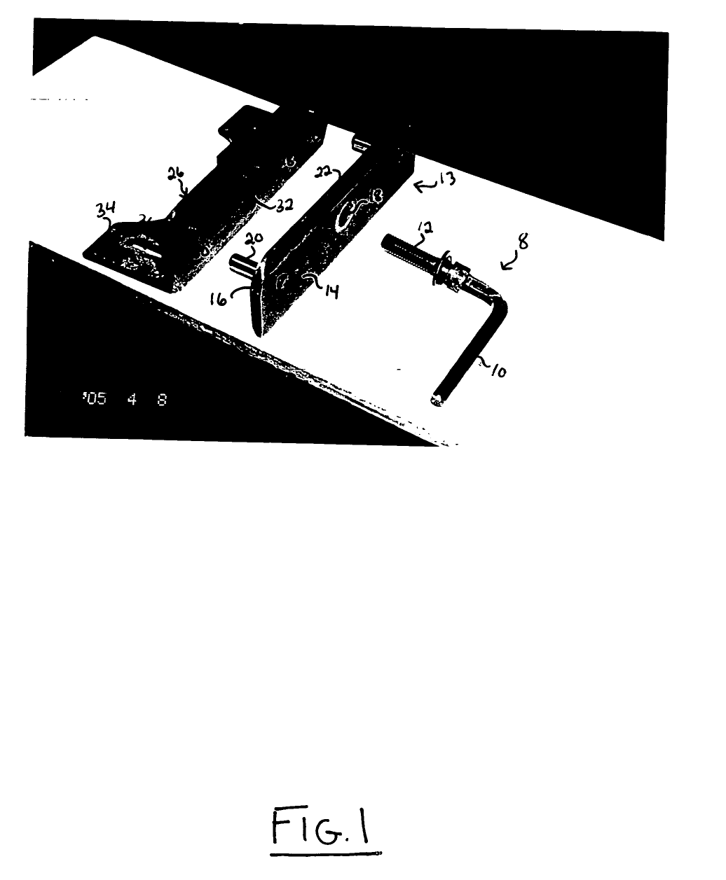

FIG. 1A shows a chainsaw chain according to one possible embodiment. The chainsaw chain 50 has cutting links 58 and drive links 56, which are pivotally connected via connecting links 60 and rivets 54. The cutting links 58 and the connecting links 60 are in the form of so-called side links in the embodiment shown, while the drive links 56 are in the form of so-called center links, each between two of these side links. The chainsaw chain 50, driven in the direction of chain travel 62 along a track 64, is supported such that it revolves on a guide bar, not shown in detail here, which is mounted on a portable motor-driven tool. The motor drives a sprocket wheel (not shown), the tooth gaps of which are engaged by the drive links 56. The cutting link 58 has a cutting tooth 52 on the top of its rear portion.

FIG. 1 shows a side perspective view of the pieces of the clamping device 6 disassembled. The clamping device 6 comprises a handle portion 8, which handle portion 8 serves the purpose of connecting the inner plate 26, the outer plate 14, and the handle portion 8 together, as well as tightening and loosening the clamping device 6 during use. When assembled, the clamping device 6 is configured to hold a chainsaw chain 40 tightly and securely so the chainsaw chain can be easily sharpened using a file or other sharpening implement.

The handle portion 8 comprises a turning portion 10 that is configured to be rotated by the hand of a user. The handle portion 8 further comprises a handle screw 12 disposed at the end of the turning portion. The handle screw 12 is threaded to allow the handle portion to be screwed securely into the inner plate 26 and the outer plate 14 of the clamping device 6.

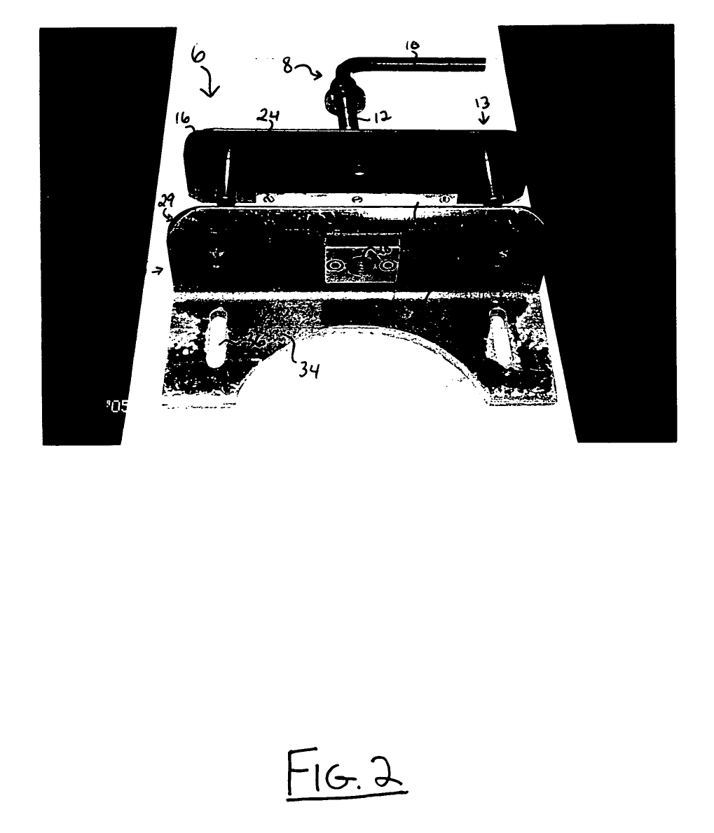

FIG. 1 further shows the outer portion 13 of the clamping device 6, comprising an outer plate 14. The outer plate 14 is essentially rectangular and comprises rounded upper edges 16 and a smooth inner face 24 (FIG. 2). The upper portion of the outer plate 14 comprises a beveled edge 22. The outer plate 14 further comprises a spacer element 17 (FIG. 2) that is disposed at the bottom of the smooth inner face 24. The spacer element 17 is approximately the same width as the drive links of a chainsaw chain, and is designed to maintain the drive links between the outer portion 13 and the inner portion 25 during sharpening. In one possible embodiment of the clamping device 6, the outer plate 14 has a width of approximately 20.3 cm and a height of approximately 8.9 cm. In other possible embodiments, the height and width of the outer plate 14 could be larger or smaller. The above measurements are not meant to limit the present application in any way.

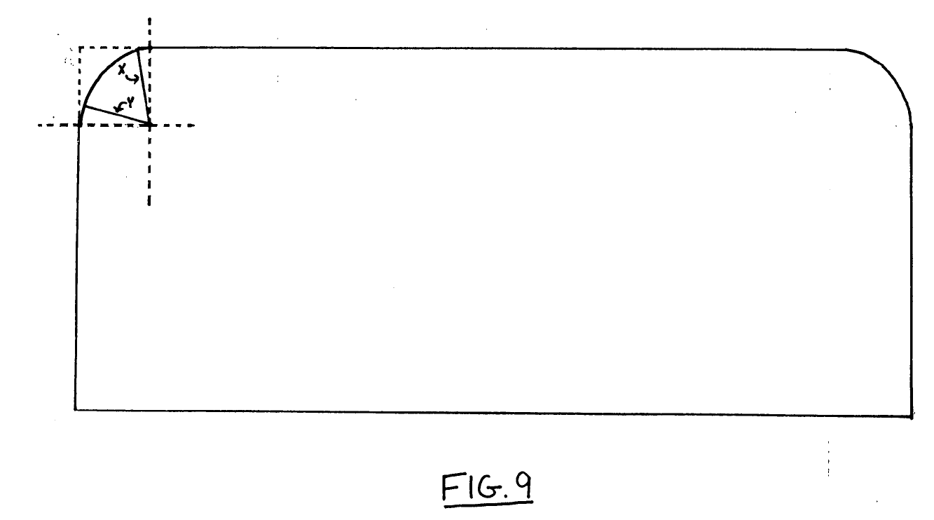

As shown in FIG. 9, in one possible embodiment, the rounded upper edges 16 of the outer plate 14 have a larger radius of curvature at the side of the curve, that is, on the side edges of the outer plate 14, and a smaller radius of curvature at the top of the curve, that is, on the upper edge of the outer plate 14. The radius Y of curvature of the lower curve is in the range of 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 27 mm, 29 mm, and 30 mm. The radius Y of curvature of the lower curve could also be any tenth of a millimeter between the above range, such as, for example, 10.0 mm, 10.1 mm, 10.2 mm . . . 29.8 mm, 29.9 mm, 30.0 mm. The radius X of the upper curve is in the range of 8 mm, 9 mm, 10 mm, 11 mm, 12 mm, 13 mm, 14 mm, 15 mm, 16 mm, 17 mm, 18 mm, 19 mm, 20 mm, 21 mm, and 22 mm. The radius X of curvature of the upper curve could also be any tenth of a millimeter between the above range, such as, for example, 8.0 mm, 8.1 mm, 8.2 mm, 8.3 mm . . . 21.8 mm, 21.9 mm, 22.0 mm.

The rounded upper edges 16 are configured to allow a chainsaw chain 40 to easily glide along the upper edge of the clamping device 6 when the chainsaw chain 40 is advanced for further sharpening. The outer plate 14 further comprises a hole 18 that is configured to receive the handle screw 12 for assembling and for tightening the clamping device 6. Dow pins 20 are also disposed on the smooth inner face 24 of the outer plate 14 for the assembly of the clamping device 6. The dow pins 20 extend horizontally away from the smooth inner face 24 of the outer plate.

The inner portion 25 is essentially L-shaped and comprises a vertical inner plate 26 and a horizontal mounting piece 34. The horizontal mounting piece 34 is disposed substantially perpendicularly to the vertical inner plate 26, and the vertical inner plate 26 extends upwardly from the mounting piece 34. The inner plate 26 comprises a smooth inner face 32, and the upper side of the inner plate 26 comprises a beveled edge 27 and rounded edges 29. When placed together, the beveled edge 22 of the outer plate and the beveled edge 27 of the inner plate meet to form a raised track 37 for a chainsaw chain 40 to lie across for sharpening. The inner plate 26 further comprises a threaded hole 28 that is configured to receive the handle screw 12 for assembly and for tightening of the clamping device 6. Dow pin holes 30 are disposed in the inner plate 26 and are designed to receive the dow pins 20 during assembly and tightening of the clamping device 6.

As shown in FIG. 9, in one possible embodiment, the rounded upper edges 29 of the inner plate 26 have a larger radius of curvature at the side of the curve, that is, on the side edges of the outer plate 26, and a smaller radius of curvature at the top of the curve, that is, on the top edge of the outer plate 26. The radius Y of curvature of the lower curve is in the range of 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 27 mm, 29 mm, and 30 mm. The radius of curvature of the lower curve could also be any tenth of a millimeter between the above range, such as, for example, 10.0 mm, 10.1 mm, 10.2 mm . . . 29.8 mm, 29.9 mm, 30.0 mm. The radius X of the upper curve is in the range of 8 mm, 9 mm, 10 mm, 11 mm, 12 mm, 13 mm, 14 mm, 15 mm, 16 mm, 17 mm, 18 mm, 19 mm, 20 mm, 21 mm, and 22 mm. The radius X of curvature of the upper curve could also be any tenth of a millimeter between the above ranges, such as, for example, 8.0 mm, 8.1 mm, 8.2 mm, 8.3 mm . . . 21.8 mm, 21.9 mm, 22.0 mm. It should be noted that the dimensions of the rounded upper edges 16 of the outer plate 14 and rounded upper edges 29 of the inner plate 26 are substantially identical so the plates match when the clamping device is assembled, in at least one embodiment.

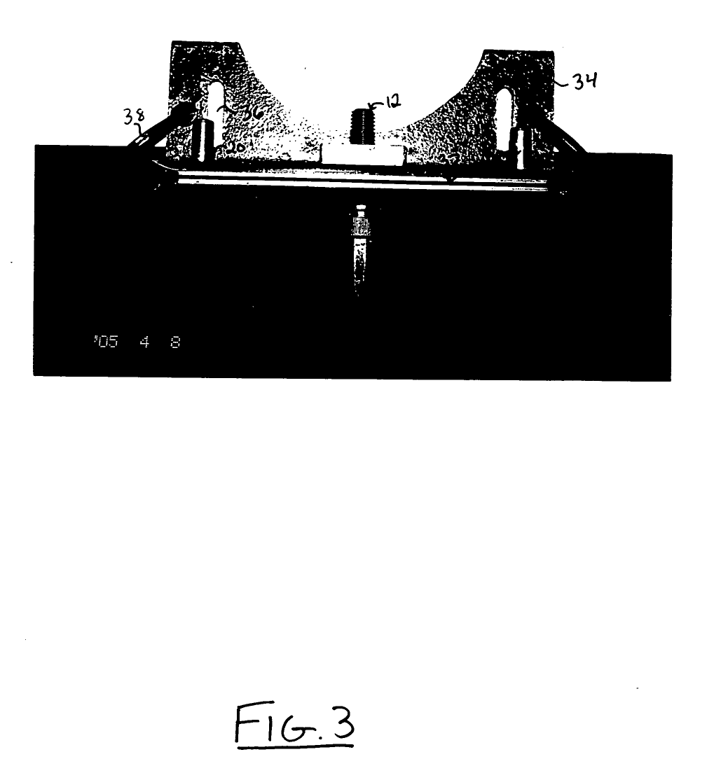

The clamping device 6 can be mounted to a flat table, or any flat surface area for use, such as on the gate of a pickup truck, on a board at a work site, or any other flat and sturdy surface area. The mounting piece 34 of the inner portion 25 comprises mounting holes 36 for bolting the clamping device to a flat surface. In alternate embodiments, the clamping device can be mounted to a flat surface using C-clamps, as shown in FIG. 3.

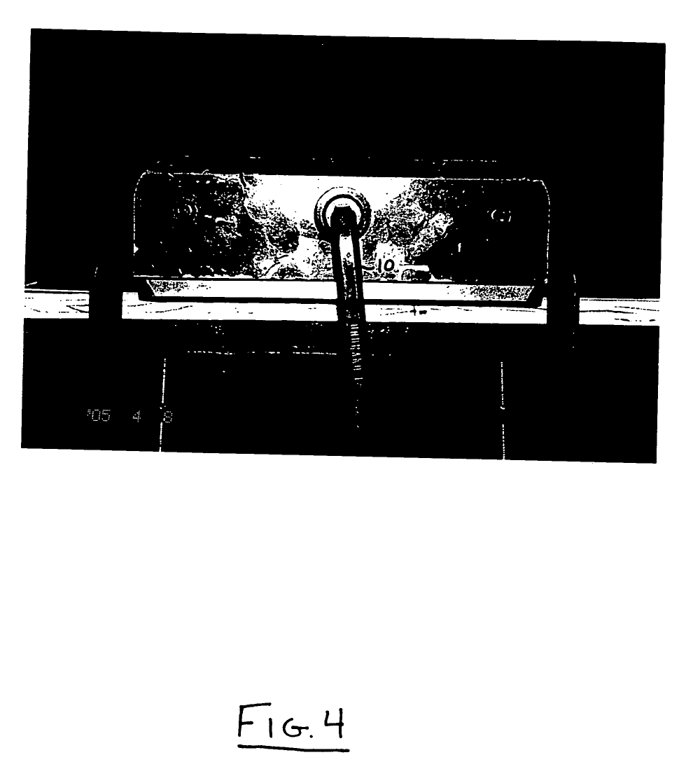

FIG. 2 shows an overhead perspective view of the pieces of the clamping device disassembled according to one possible embodiment. To assemble the clamping device 6, the dow pins 20 are inserted into the dow pin holes 30 on the inner plate 26. The handle portion 8 is then installed by screwing the handle screw 12 into the hole 18 on the outer plate 14. Once the handle screw 12 has passed through the hole 18, the user continues to rotate the turning portion 10 so that the handle screw comes into contact with the hole 28 of the inner plate 26. At this point, the user continues to rotate the turning portion 10 so that the handle screw 12 continues to be screwed into the threaded hole 28 of the inner plate 26. The handle portion 8, the outer plate 14, and the inner portion 25 are now connected to form a clamping device for a chainsaw chain 40. The beveled edge 22 of the outer plate and the beveled edge 27 of the inner plate come together to form a track 37 for the chainsaw chain. As shown in FIGS. 3 and 4, the clamping device 6 can be mounted to a table using C-clamps 38. Alternatively, the clamping device 6 could be bolted to a table using the mounting holes 36.

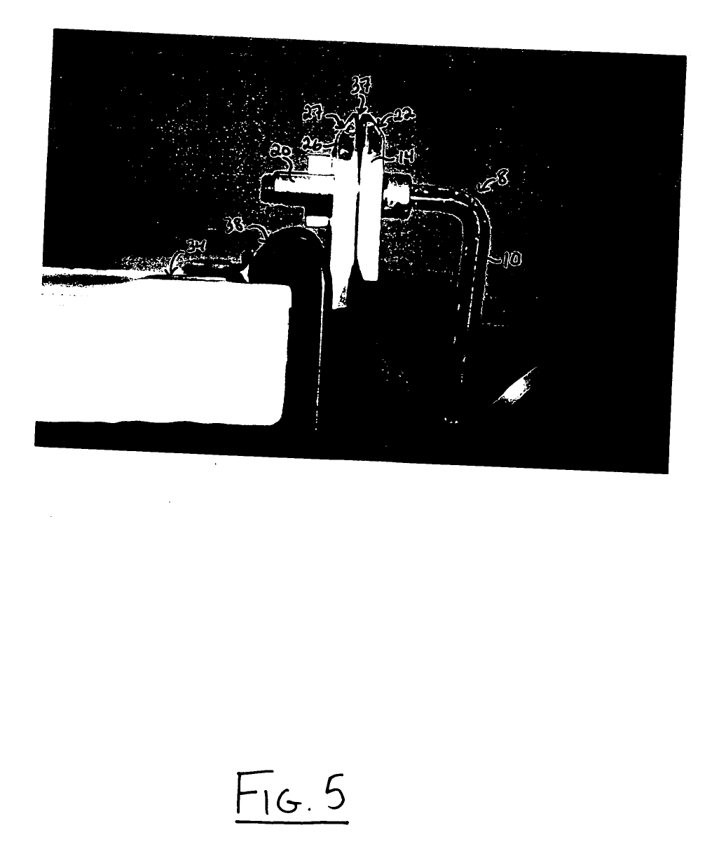

FIG. 5 shows a side view of the clamping device 6 assembled and mounted to a table using a C-clamp 38. In FIG. 5, the handle screw 12 has been fully inserted into the threaded hole 28 of the inner plate 26, and the handle screw 12 extends outwardly away from the inner plate 26. The smooth inner face 24 of the outer plate and the smooth inner face 32 of the inner plate 26 meet to form a clamping mechanism for holding a chainsaw chain 40. The dow pins 20 are fully extended through the dow pin holes 30.

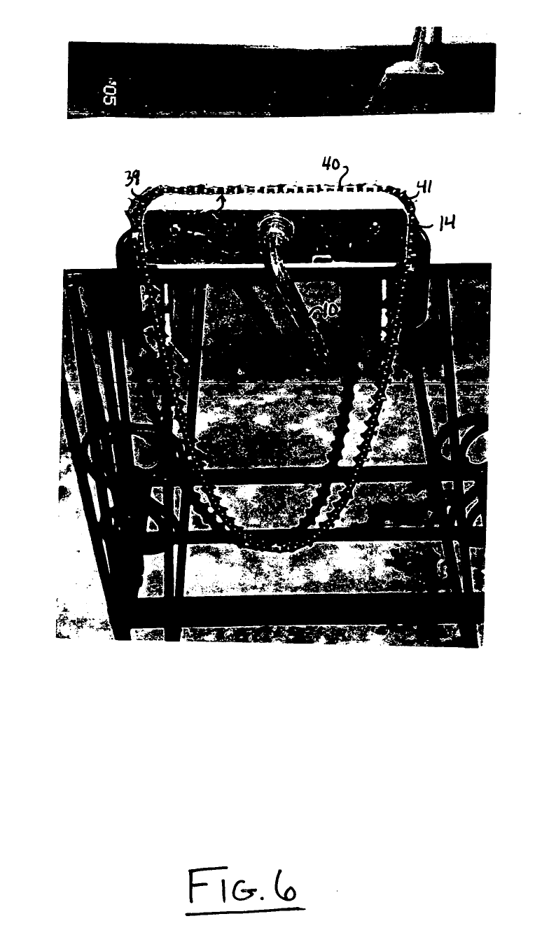

FIG. 6 shows a chainsaw chain 40 installed on the clamping device 6. The chainsaw chain 40 is placed so that the drive links of the chainsaw chain are clamped by the smooth inner face 24 of the outer plate and the smooth inner face 32 of the inner plate along the track 37. The chainsaw chain 40 is gripped by the clamping device just below the rivets of the chainsaw chain 40. This gripping position is advantageous because it prevents the teeth of the chain from being bent or otherwise distorted by the clamping device, while also fully exposing the teeth and rakers for sharpening. The chainsaw chain 40 lies across the track 37 and is guided over each of the rounded edges 16 of the outer plate and the rounded edges 29 of the inner portion, which rounded edges 16 and 29 have joined to form a left rounded top edge 39, a right rounded top edge 41, and two sides 33 of the clamping device 6. The chainsaw chain 40 is further guided down the sides 33 of the clamping device 6, where it is clamped by the clamping device 6, in order to provide a steady grip of the chainsaw chain 40. In addition, since the chainsaw chain 40 is gripped on three sides of the clamping device 6, the chainsaw chain 40 lays in an orderly manner so that it can be easily rotated through the clamping device during sharpening. The remainder of the chainsaw chain 40 hangs down from the clamping device, ready to be sharpened at the next interval.

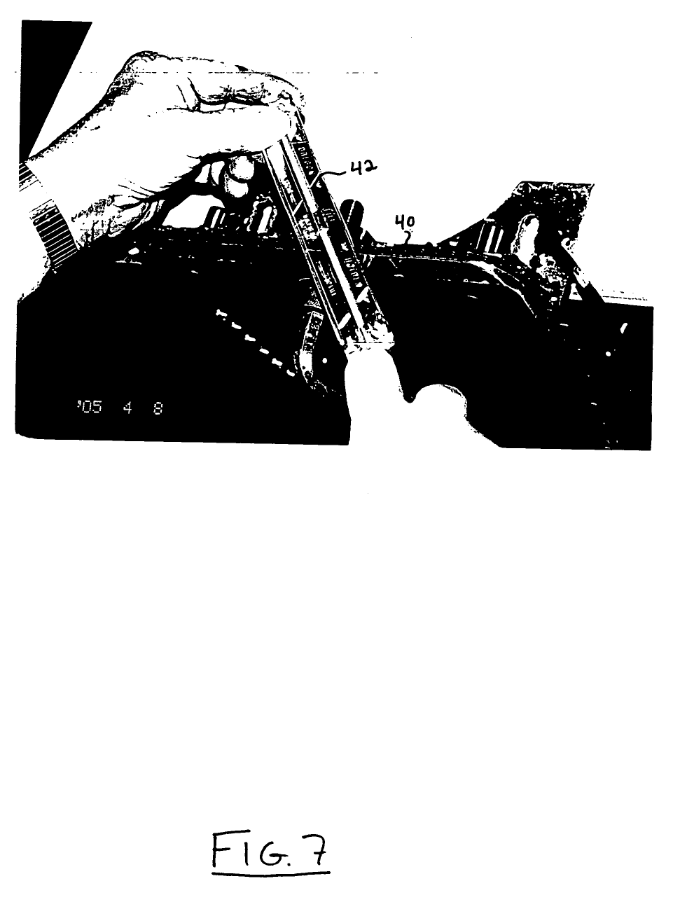

To sharpen the chainsaw chain 40, a user first makes a reference mark on the chainsaw chain to mark a starting point for sharpening. The user then places the chainsaw chain 40 across the track 37 and down both sides 33 of the clamping device 6, then rotates the turning portion 10 of the handle portion 8 so that the clamping device tightens and clamps the drive links of the chainsaw chain, below the rivets of the chainsaw chain 40. Once the chainsaw chain is securely clamped in the clamping device 6, a user utilizes a standard chainsaw chain sharpening tool to sharpen every other tooth of the chainsaw chain 40 that is protruding from the track 37, beginning with the teeth that point away from the user. The user makes the appropriate number of strokes against the teeth of the chainsaw chain to adequately sharpen each tooth. FIG. 7 shows the appropriate sharpening motion of a file 42 for a chainsaw chain 40 resting on the track 37.

Once every other tooth on the first interval has been sharpened, the user rotates the handle portion in the opposite direction in order to loosen the clamping device, and thus the chainsaw chain 40, just enough to enable the user to pull one side of the chainsaw chain in a downward vertical motion, such that the chainsaw chain easily glides over the track 37 and the sides 33 of the inner plate and outer plate, without requiring the chain to be completely removed from the device. The user can pull one side of the chainsaw chain 40 in a downward motion to advance to the next interval, or the user can slide the chainsaw chain along the top of the clamping device to advance to the next interval. The rounded top edges 39 and 41 allow the chainsaw chain 40 to glide to the next chain interval without snagging or catching the upper corners of the clamping device. According to one possible embodiment, approximately eight inches of chainsaw chain can be sharpened at each interval. The user continues sharpening every other tooth of the chainsaw chain 40 until he arrives back at the starting point reference mark. Next, the user reverses the chain, and continues to file the remainder of the teeth, sharpening every other tooth that is pointing away from the user.

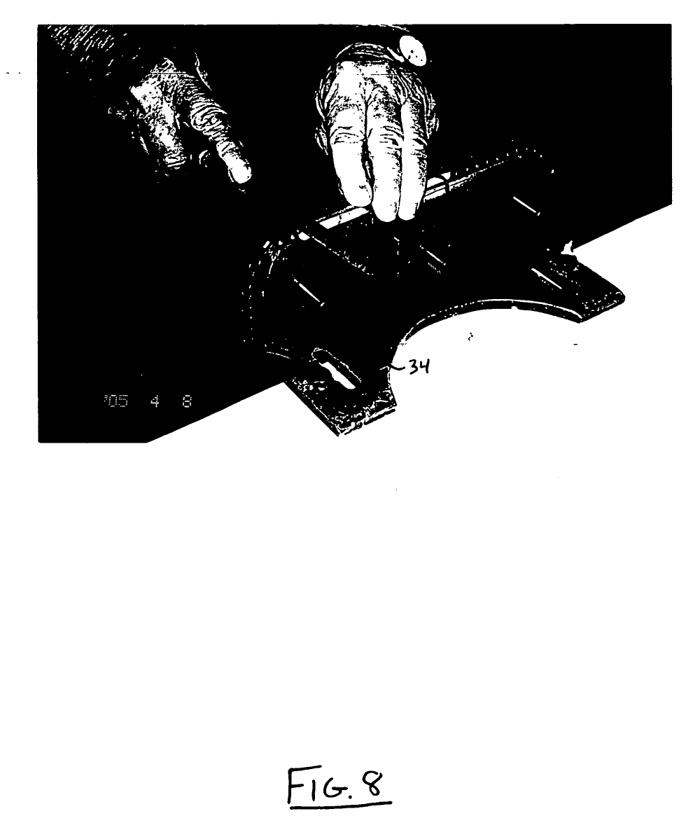

Once the teeth have been sharpened, the user next lays a raker gauge 44 across the chainsaw chain 40, as shown in FIG. 8. The user then uses a file 46 to sharpen each raker on the interval of chainsaw chain 40 that lays across the track 37. Once all rakers have been sharpened on the first interval, the user loosens the clamping device by rotating the turning portion 10 and advances the chainsaw chain 40 to the next interval. When the next interval of the chainsaw chain 40 lays across the track 37, the user tightens the clamping device by rotating the turning portion 10 and continues to file the rakers. The user continues in this manner until all of the rakers on the chainsaw chain 40 have been sharpened. When all teeth and rakers have been sharpened, the user can remove the chainsaw chain 40 from the clamping device 6 and install it back on the chain saw.

One feature or aspect of an embodiment is believed at the time of the filing of this patent application to possibly reside broadly in a clamping device for holding a chainsaw chain to be sharpened, said clamping device comprising: a handle portion; a first plate portion; a second plate portion; a mounting arrangement being configured and disposed to mount said clamping device to a supporting structure; said handle portion comprising a turning portion being configured to be rotated by a user; said handle portion comprising a handle screw comprising screw threading and being disposed substantially perpendicularly to said turning portion; each of said first plate portion and said second plate portion being substantially rectangular in shape; each of said first plate portion and said second plate portion comprising two rounded upper corners; one of said first plate portion or said second plate portion comprising a plurality of dow pins, and the other of said first plate portion or said second plate portion comprising dow pin holes being configured and disposed to receive said dow pins; one of said first plate portion or said second plate portion comprising a spacer element being configured and disposed to permit said clamping device to clamp the drive links of a chainsaw chain between said first plate portion and said second plate portion, and to maintain the drive links of a chainsaw chain between said first plate portion and said second plate portion during the advancing of the chainsaw chain for further sharpening; said second plate portion comprising a hole being configured and disposed to receive said handle screw; said first plate portion comprising a threaded hole being configured and disposed to receive said handle screw and to permit tightening of said clamping device; said second plate portion being configured to be coupled with said first plate portion with said handle screw and said dow pins to form said clamping device; said second plate portion being disposed nearest to said turning portion upon assembly and said first plate portion being disposed farthest away from said turning portion upon assembly; said clamping device, upon assembly, comprising a top edge portion, a first rounded upper corner, a second rounded upper corner, a first side edge portion and a second side edge portion; said clamping device being configured to clamp the drive links of a chainsaw chain below the rivets of a chainsaw chain about said first side edge portion, said first rounded upper corner, said top edge portion, said second rounded upper corner, and said second side edge portion of said clamping device; said first rounded upper corner and said second rounded upper corner being configured and disposed to permit a chainsaw chain to glide smoothly over said first rounded upper corner and said second rounded upper corner; and said clamping device being configured and disposed to permit a chainsaw chain to be clamped for sharpening, then to be unclamped and moved up said first side edge portion, about said first rounded upper corner, across said top edge portion, about said second rounded corner, and down said second side edge portion of said clamping device by pulling one side of the chainsaw chain in a downward vertical motion, without requiring the removal of the chainsaw chain from said clamping device.

Another feature or aspect of an embodiment is believed at the time of the filing of this patent application to possibly reside broadly in a clamping device, wherein: the radius of curvature of the lower curves of said first rounded upper corner and said second rounded upper corner is between 10 mm and 30 mm; and the radius of curvature of the upper curves of said first rounded upper corner and said second rounded upper corner is between 8 mm and 22 mm.

Yet another feature or aspect of an embodiment is believed at the time of the filing of this patent application to possibly reside broadly in a clamping device, wherein the radius of curvature of said first rounded upper corner and said second rounded upper corner is greatest at the sides of the curves, and smallest at the tops of the curves.

Still another feature or aspect of an embodiment is believed at the time of the filing of this patent application to possibly reside broadly in a clamping device, wherein said first rounded upper corner and said second rounded upper corner form part of an oval or ellipse.

A further feature or aspect of an embodiment is believed at the time of the filing of this patent application to possibly reside broadly in a clamping device, wherein said clamping device is constructed with stock size steel.

Another feature or aspect of an embodiment is believed at the time of the filing of this patent application to possibly reside broadly in a clamping device, wherein said first plate portion and said second plate portion are configured to permit approximately 8 inches of chainsaw chain to be sharpened at each interval.

Yet another feature or aspect of an embodiment is believed at the time of the filing of this patent application to possibly reside broadly in a clamping device, wherein said clamping device is mounted to a surface using C-clamps or bolts.

Still another feature or aspect of an embodiment is believed at the time of the filing of this patent application to possibly reside broadly in a clamping device for holding a chainsaw chain to be sharpened, said clamping device comprising: a handle portion being configured to be turned by a user; a first plate; a second plate; said first plate and said second plate comprising rounded upper corners; a mounting arrangement being configured and disposed to mount said clamping device to a supporting structure; said handle portion comprising a handle screw comprising screw threading; said handle screw being configured to tighten said first plate to said second plate; said clamping device, upon assembly, comprising at least one of A-E: A. a first side edge portion and a second side edge portion being configured and disposed to clamp the drive links of a chainsaw chain below the rivets of a chainsaw chain; B. a top edge portion being configured to clamp the drive links of a chainsaw chain below the rivets of a chainsaw chain; C. a first rounded upper corner and a second rounded upper corner being configured and disposed to clamp the drive links of a chainsaw chain below the rivets of a chainsaw chain; said first rounded upper corner and a second rounded upper corner being configured to permit a chainsaw chain to glide smoothly over said first rounded upper corner and said second rounded upper corner; D. a first side edge portion and a second side edge portion being configured and disposed to clamp the drive links of a chainsaw chain below the rivets of a chainsaw chain E. a spacer element being configured and disposed to permit said clamping device to clamp the drive links of a chainsaw chain below the rivets of a chainsaw chain between said first plate and said second plate, and to maintain the drive links of a chainsaw chain between said first plate and said second plate during the advancing of the chainsaw chain for further sharpening.

A further feature or aspect of an embodiment is believed at the time of the filing of this patent application to possibly reside broadly in a clamping device, wherein: the radius of curvature of the lower curves of said first rounded upper corner and said second rounded upper corner is between 10 mm and 30 mm; and the radius of curvature of the upper curves of said first rounded upper corner and said second rounded upper corner is between 8 mm and 22 mm.

Another feature or aspect of an embodiment is believed at the time of the filing of this patent application to possibly reside broadly in a clamping device, wherein the radius of curvature of said first rounded upper corner and said second rounded upper corner is greatest at the sides of the curves, and smallest at the tops of the curves.

Yet another feature or aspect of an embodiment is believed at the time of the filing of this patent application to possibly reside broadly in a clamping device, wherein said first rounded upper corner and said second rounded upper corner form part of an oval or ellipse.

Still another feature or aspect of an embodiment is believed at the time of the filing of this patent application to possibly reside broadly in a clamping device, wherein said clamping device is constructed with stock size steel.

A further feature or aspect of an embodiment is believed at the time of the filing of this patent application to possibly reside broadly in a clamping device, wherein said first plate and said second plate are configured to permit approximately 8 inches of chainsaw chain to be sharpened at each interval.

Another feature or aspect of an embodiment is believed at the time of the filing of this patent application to possibly reside broadly in a clamping device, wherein said clamping device is mounted to a surface using C-clamps or bolts.

Yet another feature or aspect of an embodiment is believed at the time of the filing of this patent application to possibly reside broadly in a method of sharpening a chainsaw chain using a clamping device, said clamping device comprising: a handle portion being configured to be turned by a user; a first plate; a second plate; said first plate and said second plate comprising rounded upper corners; a mounting arrangement being configured and disposed to mount said clamping device to a supporting structure; said handle portion comprising a handle screw comprising screw threading; said handle screw being configured to tighten said first plate to said second plate; said clamping device, upon assembly, comprising at least one of A-E: A. a first side edge portion and a second side edge portion being configured and disposed to clamp the drive links of a chainsaw chain below the rivets of a chainsaw chain; B. a top edge portion being configured to clamp the drive links of a chainsaw chain below the rivets of a chainsaw chain; C. a first rounded upper corner and a second rounded upper corner being configured and disposed to clamp the drive links of a chainsaw chain below the rivets of a chainsaw chain; said first rounded upper corner and a second rounded upper corner being configured to permit a chainsaw chain to glide smoothly over said first rounded upper corner and said second rounded upper corner; D. a first side edge portion and a second side edge portion being configured and disposed to clamp the drive links of a chainsaw chain below the rivets of a chainsaw chain E. a spacer element being configured and disposed to permit said clamping device to clamp the drive links of a chainsaw chain below the rivets of a chainsaw chain between said first plate and said second plate, and to maintain the drive links of a chainsaw chain between said first plate and said second plate during the advancing of the chainsaw chain for further sharpening; said method comprising the steps of: turning said handle portion to loosen said clamping device; marking a reference mark on a tooth of a chainsaw chain; aligning the chainsaw chain about said first side edge portion, said first rounded upper corner, said top edge portion, said second rounded upper corner, and said second side edge portion of said clamping device with said reference mark at one of said left rounded upper corner or said right rounded upper corner of said clamping device; turning said handle portion to tighten said clamping device below the rivets and about the drive links of the chainsaw chain; sharpening the teeth of the chainsaw chain disposed on said top edge portion of said clamping device; turning said handle portion and loosening said clamping device, and thus loosening the chainsaw chain, upon the teeth disposed on said top edge portion of said clamping device being sharpened; pulling one side of a chainsaw chain in a downward vertical motion and moving the chainsaw chain up said first side edge portion, about said first rounded upper corner, across said top edge portion, about said second rounded corner, and down said second side edge portion, in order to advance the chainsaw chain to the next interval on said top portion of said clamping device to be sharpened; turning said handle portion and tightening said clamping device and thus tightening the chainsaw chain in said clamping device; repeating the above steps until the teeth have been sharpened; reversing the chainsaw chain and repeating the above steps until the teeth desired to be sharpened have been sharpened; using a raker gauge and a file to sharpen the rakers of the chainsaw chain; repeating the above steps until all rakers have been sharpened; and removing the chainsaw chain from said clamping device.

Still another feature or aspect of an embodiment is believed at the time of the filing of this patent application to possibly reside broadly in a method of sharpening a chainsaw chain using a clamping device, wherein: the radius of curvature of the lower curves of said first rounded upper corner and said second rounded upper corner is between 10 mm and 30 mm; and the radius of curvature of the upper curves of said first rounded upper corner and said second rounded upper corner is between 8 mm and 22 mm.

A further feature or aspect of an embodiment is believed at the time of the filing of this patent application to possibly reside broadly in a method of sharpening a chainsaw chain using a clamping device, wherein the radius of curvature of said first rounded upper corner and said second rounded upper corner is greatest at the sides of the curves, and smallest at the tops of the curves.

Another feature or aspect of an embodiment is believed at the time of the filing of this patent application to possibly reside broadly in a method of sharpening a chainsaw chain using a clamping device, wherein said first rounded upper corner and said second rounded upper corner form part of an oval or ellipse.

Yet another feature or aspect of an embodiment is believed at the time of the filing of this patent application to possibly reside broadly in a method of sharpening a chainsaw chain using a clamping device, wherein said clamping device is constructed with stock size steel.

Still another feature or aspect of an embodiment is believed at the time of the filing of this patent application to possibly reside broadly in a method of sharpening a chainsaw chain using a clamping device, wherein: said first plate and said second plate are configured to permit approximately 8 inches of chainsaw chain to be sharpened at each interval; and said clamping device is mounted to a surface using C-clamps or bolts.

Some examples of chainsaw chain sharpeners or methods of sharpening chainsaw chains, components of which may possibly be utilized in at least one possible embodiment, may possibly be found in the following U.S. Pat. No. 6,334,809, entitled “Method and system for sharpening teeth on saw chains;” U.S. Pat. No. 6,161,453, entitled “Saw chain sharpener for a chain saw;” U.S. Pat. No. 6,058,806, entitled “Automatic chain saw sharpener;” U.S. Pat. No. 6,006,629, entitled “Automatic chain sharpening device mounted on a chain saw;” U.S. Pat. No. 5,983,755, entitled “Chain saw sharpening apparatus with unique disassembly feature;” U.S. Pat. No. 5,816,118, entitled “Chain saw sharpening bench;” U.S. Pat. No. 5,241,882, entitled “Filing gauge for saw chains;” U.S. Pat. No. 5,174,173, entitled “Round file holder for a chain saw sharpener;” U.S. Pat. No. 5,156,071, entitled “Chain saw sharpener with built-up grinding tool;” U.S. Pat. No. 5,107,726, entitled “Chain saw sharpener;” U.S. Pat. No. 4,966,055, entitled “Chain saw sharpening device;” U.S. Pat. No. 4,888,872, entitled “Chain saw attachment;” U.S. Pat. No. 4,864,897, entitled “Chain saw sharpening tool;” U.S. Pat. No. 4,846,385, entitled “Lockable mounting bracket for chain saws;” U.S. Pat. No. 4,843,718, entitled “Automatic sharpener for chain saw;” U.S. Pat. No. 4,727,777, entitled “Vehicle-mounted support for sharpening chain saws;” U.S. Pat. No. 4,727,776, entitled “Chain saw sharpening system;” U.S. Pat. No. 4,699,026, entitled “Apparatus for sharpening chain saw chains;” U.S. Pat. No. 4,683,780, entitled “Saw chain sharpener;” U.S. Pat. No. 4,677,881, entitled “Chain saw sharpener;” U.S. Pat. No. 4,646,589, entitled “Chain saw sharpener aid;” U.S. Pat. No. 4,597,178, entitled “Saw chain sharpener;” U.S. Pat. No. 4,594,919, entitled “Sharpening of chain saws;” U.S. Pat. No. 4,581,968, entitled “Saw chain with improved cutting depth control;” U.S. Pat. No. 4,567,792, entitled “Saw chain sharpening device;” U.S. Pat. No. 4,535,667, entitled “Saw chain;” U.S. Pat. No. 4,535,654, entitled “Chain saw sharpening guide;” U.S. Pat. No. 4,530,258, entitled “Saw chain sharpening method and apparatus;” U.S. Pat. No. 4,503,735, entitled “Chain saw sharpening device;” U.S. Pat. No. 4,463,630, entitled “Chain-saw chain sharpening device;” U.S. Pat. No. 4,463,499, entitled “Portable chain saw sharpening kit with depth gauge filing attachment;” U.S. Pat. No. 4,457,069, entitled “Sharpening device for a chain saw;” U.S. Pat. No. 4,438,667, entitled “Sharpening device for a chain saw;” U.S. Pat. No. 4,435,999, entitled “Saw sharpening guide;” U.S. Pat. No. 4,429,596, entitled “Rotary steel filing apparatus for sharpening saw chains;” U.S. Pat. No. RE31,504, entitled “Saw chain sharpening fixture;” U.S. Pat. No. 4,412,463, entitled “Chain saw sharpening guide;” U.S. Pat. No. 4,404,872, entitled “Portable chain saw sharpening kit with depth gauge filing attachment and method of using same;” U.S. Pat. No. 4,404,871, entitled “Portable chain saw sharpening kit with cutting link alignment means and method for using same;” U.S. Pat. No. 4,393,739, entitled “Top sharpening chain;” U.S. Pat. No. 4,385,532, entitled “Sharpening device for a back-sharpened saw chain of a motor chain saw;” U.S. Pat. No. 4,375,173, entitled “Saw chain holding device;” U.S. Pat. No. 4,370,905, entitled “Chain tooth locator;” U.S. Pat. No. 4,355,551, entitled “Chain saw bar attachment;” U.S. Pat. No. 4,336,726, entitled “Chain stop for saw chain grinder;” U.S. Pat. No. 4,325,168, entitled “File for a chain saw;” U.S. Pat. No. 4,319,502, entitled “Portable saw chain sharpener;” U.S. Pat. No. 4,299,142, entitled “Grinding machine with reorientable chain holding clamp;” U.S. Pat. No. 4,287,793, entitled “Universal saw chain grinding machine;” U.S. Pat. No. 4,277,987, entitled “Chain saw sharpening apparatus;” U.S. Pat. No. 4,248,412, entitled “Support for sharpening chain saws at the work site;” U.S. Pat. No. 4,235,131, entitled “Depth gauge grinding attachment for saw chain sharpener;” U.S. Pat. No. 4,228,702, entitled “File guide for use in sharpening a chain saw;” U.S. Pat. No. 4,193,326, entitled “Holding apparatus for sharpening chain saws;” U.S. Pat. No. 4,177,697, entitled “Apparatus for sharpening a chain saw;” U.S. Pat. No. 4,173,908, entitled “Saw chain sharpening fixture;” U.S. Pat. No. 4,104,793, entitled “Saw chain sharpener;” U.S. Pat. No. 4,102,223, entitled “Automatic sharpening machine for saw chains;” U.S. Pat. No. 4,062,253, entitled “Chain saw sharpener;” U.S. Pat. No. 4,060,895, entitled “Non-symmetrical bar with reversible body portion;” U.S. Pat. No. 4,044,635, entitled “Saw chain sharpener;” U.S. Pat. No. 4,040,314, entitled “Chain saw blade sharpening accessory;” U.S. Pat. No. 4,019,407, entitled “Saw chain grinder fixture;” U.S. Pat. No. 4,010,661, entitled “Chain saw sharpening tool;” U.S. Pat. No. 3,952,615, entitled “Saw chain sharpening system;” and U.S. Pat. No. 3,935,757, entitled “Chain saw tool.”

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL LIST OF TERMS

6 clamping device
8 handle portion
10 turning portion
12 handle screw
13 outer portion
14 outer plate
16 outer plate rounded edges
17 spacer element
18 hole for handle screw (outer plate)
20 dow pins
22 beveled edge of outer plate
24 smooth inner face of outer plate
25 inner portion
26 inner plate
27 beveled edge of inner plate
28 threaded hole for handle screw (inner plate)
29 inner plate rounded edges
30 holes for dow pins
32 smooth inner face of inner plate
33 sides of plates
34 mounting piece
36 mounting holes
37 track for chainsaw chain
38 C-clamp
39 left rounded top edge
40 chainsaw chain
41 right rounded top edge
42 file for teeth
44 raker guage
46 flat file for rakers

What is claimed is:

1. A clamping device for holding a chainsaw chain to be sharpened, said clamping device comprising:
a handle portion;
a first plate portion;
a second plate portion;
a mounting arrangement being configured and disposed to mount said clamping device to a supporting structure;
said handle portion comprising a turning portion being configured to be rotated by a user;
said handle portion comprising a handle screw comprising screw threading and being disposed substantially perpendicularly to said turning portion;
each of said first plate portion and said second plate portion being substantially rectangular in shape;
each of said first plate portion and said second plate portion comprising two rounded upper corners;
one of said first plate portion or said second plate portion comprising a plurality of dow pins, and the other of said first plate portion or said second plate portion comprising dow pin holes being configured and disposed to receive said dow pins;
one of said first plate portion or said second plate portion comprising a spacer element being configured and disposed to permit said clamping device to clamp the drive links of a chainsaw chain between said first plate portion and said second plate portion, and to maintain the drive links of a chainsaw chain between said first plate portion and said second plate portion during the advancing of the chainsaw chain for further sharpening;
said second plate portion comprising a hole being configured and disposed to receive said handle screw;
said first plate portion comprising a threaded hole being configured and disposed to receive said handle screw and to permit tightening of said clamping device;
said second plate portion being configured to be coupled with said first plate portion with said handle screw and said dow pins to form said clamping device;
said second plate portion being disposed nearest to said turning portion upon assembly and said first plate portion being disposed farthest away from said turning portion upon assembly;
said clamping device, upon assembly, comprising a top edge portion, a first rounded upper corner, a second rounded upper corner, a first side edge portion and a second side edge portion;
said clamping device being configured to clamp the drive links of a chainsaw chain below the rivets of a chainsaw chain about said first side edge portion, said first rounded upper corner, said top edge portion, said second rounded upper corner, and said second side edge portion of said clamping device;
said first rounded upper corner and said second rounded upper corner being configured and disposed to permit a chainsaw chain to glide smoothly over said first rounded upper corner and said second rounded upper corner; and
said clamping device being configured and disposed to permit a chainsaw chain to be clamped for sharpening, then to be unclamped and moved up said first side edge portion, about said first rounded upper corner, across said top edge portion, about said second rounded corner, and down said second side edge portion of said clamping device by pulling one side of the chainsaw chain in a downward vertical motion, without requiring the removal of the chainsaw chain from said clamping device.

2. The clamping device according to claim 1, wherein:
the radius of curvature of the lower curves of said first rounded upper corner and said second rounded upper corner is between 10 mm and 30 mm; and
the radius of curvature of the upper curves of said first rounded upper corner and said second rounded upper corner is between 8 mm and 22 mm.

3. The clamping device according to claim 2, wherein the radius of curvature of said first rounded upper corner and said second rounded upper corner is greatest at the sides of the curves, and smallest at the tops of the curves.

4. The clamping device according to claim 3, wherein said first rounded upper corner and said second rounded upper corner form part of an oval or ellipse.

5. The clamping device according to claim 4, wherein said clamping device is constructed with stock size steel.

6. The clamping device according to claim 5, wherein said first plate portion and said second plate portion are configured to permit approximately 8 inches of chainsaw chain to be sharpened at each interval.

7. The clamping device according to claim 6, wherein said clamping device is mounted to a surface using C-clamps or bolts.

8. A clamping device for holding a chainsaw chain to be sharpened, said clamping device comprising:
a handle portion being configured to be turned by a user;
a first plate;
a second plate;
said first plate and said second plate comprising rounded upper corners;
a mounting arrangement being configured and disposed to mount said clamping device to a supporting structure;
said handle portion comprising a handle screw comprising screw threading;
said handle screw being configured to tighten said first plate to said second plate;
said clamping device, upon assembly, comprising at least one of A-E:
A. a first side edge portion and a second side edge portion being configured and disposed to clamp the drive links of a chainsaw chain below the rivets of a chainsaw chain;
B. a top edge portion being configured to clamp the drive links of a chainsaw chain below the rivets of a chainsaw chain;
C. a first rounded upper corner and a second rounded upper corner being configured and disposed to clamp the drive links of a chainsaw chain below the rivets of a chainsaw chain;
said first rounded upper corner and a second rounded upper corner being configured to permit a chainsaw chain to glide smoothly over said first rounded upper corner and said second rounded upper corner;
D. a first side edge portion and a second side edge portion being configured and disposed to clamp the drive links of a chainsaw chain below the rivets of a chainsaw chain
E. a spacer element being configured and disposed to permit said clamping device to clamp the drive links of a chainsaw chain below the rivets of a chainsaw chain between said first plate and said second plate, and to maintain the drive links of a chainsaw chain between said first plate and said second plate during the advancing of the chainsaw chain for further sharpening.

9. The clamping device according to claim 8, wherein:
the radius of curvature of the lower curves of said first rounded upper corner and said second rounded upper corner is between 10 mm and 30 mm; and
the radius of curvature of the upper curves of said first rounded upper corner and said second rounded upper corner is between 8 mm and 22 mm.

10. The clamping device according to claim 9, wherein the radius of curvature of said first rounded upper corner and said second rounded upper corner is greatest at the sides of the curves, and smallest at the tops of the curves.

11. The clamping device according to claim 10, wherein said first rounded upper corner and said second rounded upper corner form part of an oval or ellipse.

12. The clamping device according to claim 11, wherein said clamping device is constructed with stock size steel.

13. The clamping device according to claim 12, wherein said first plate and said second plate are configured to permit approximately 8 inches of chainsaw chain to be sharpened at each interval.

14. The clamping device according to claim 13, wherein said clamping device is mounted to a surface using C-clamps or bolts.

15. A method of sharpening a chainsaw chain using a clamping device, said clamping device comprising: a handle portion being configured to be turned by a user; a first plate; a second plate; said first plate and said second plate comprising rounded upper corners; a mounting arrangement being configured and disposed to mount said clamping device to a supporting structure; said handle portion comprising a handle screw comprising screw threading; said handle screw being configured to tighten said first plate to said second plate; said clamping device, upon assembly, comprising at least one of A-E: A. a first side edge portion and a second side edge portion being configured and disposed to clamp the drive links of a chainsaw chain below the rivets of a chainsaw chain; B. a top edge portion being configured to clamp the drive links of a chainsaw chain below the rivets of a chainsaw chain; C. a first rounded upper corner and a second rounded upper corner being configured and disposed to clamp the drive links of a chainsaw chain below the rivets of a chainsaw chain; said first rounded upper corner and a second rounded upper corner being configured to permit a chainsaw chain to glide smoothly over said first rounded upper corner and said second rounded upper corner; D. a first side edge portion and a second side edge portion being configured and disposed to clamp the drive links of a chainsaw chain below the rivets of a chainsaw chain E. a spacer element being configured and disposed to permit said clamping device to clamp the drive links of a chainsaw chain below the rivets of a chainsaw chain between said first plate and said second plate, and to maintain the drive links of a chainsaw chain between said first plate and said second plate during the advancing of the chainsaw chain for further sharpening; said method comprising the steps of:
turning said handle portion to loosen said clamping device;
marking a reference mark on a tooth of a chainsaw chain;
aligning the chainsaw chain about said first side edge portion, said first rounded upper corner, said top edge portion, said second rounded upper corner, and said second side edge portion of said clamping device with said reference mark at one of said left rounded upper corner or said right rounded upper corner of said clamping device;
turning said handle portion to tighten said clamping device below the rivets and about the drive links of the chainsaw chain;
sharpening the teeth of the chainsaw chain disposed on said top edge portion of said clamping device;
turning said handle portion and loosening said clamping device, and thus loosening the chainsaw chain, upon the teeth disposed on said top edge portion of said clamping device being sharpened;
pulling one side of a chainsaw chain in a downward vertical motion and moving the chainsaw chain up said first side edge portion, about said first rounded upper corner, across said top edge portion, about said second rounded corner, and down said second side edge portion, in order to advance the chainsaw chain to the next interval on said top portion of said clamping device to be sharpened;
turning said handle portion and tightening said clamping device and thus tightening the chainsaw chain in said clamping device;
repeating the above steps until the teeth have been sharpened;
reversing the chainsaw chain and repeating the above steps until the teeth desired to be sharpened have been sharpened;
using a raker gauge and a file to sharpen the rakers of the chainsaw chain;
repeating the above steps until all rakers have been sharpened; and
removing the chainsaw chain from said clamping device.

16. The method according to claim 15, wherein:
the radius of curvature of the lower curves of said first rounded upper corner and said second rounded upper corner is between 10 mm and 30 mm; and
the radius of curvature of the upper curves of said first rounded upper corner and said second rounded upper corner is between 8 mm and 22 mm.

17. The method according to claim 16, wherein the radius of curvature of said first rounded upper corner and said second rounded upper corner is greatest at the sides of the curves, and smallest at the tops of the curves.

18. The method according to claim 17, wherein said first rounded upper corner and said second rounded upper corner form part of an oval or ellipse.

19. The method according to claim 18, wherein said clamping device is constructed with stock size steel.

20. The method according to claim 19, wherein:
said first plate and said second plate are configured to permit approximately 8 inches of chainsaw chain to be sharpened at each interval; and
said clamping device is mounted to a surface using C-clamps or bolts.
